(19) United States
(12) Patent Application Publication
(10) Pub. No.: US 2025/0313310 A1
(43) Pub. Date: Oct. 9, 2025

(54) ASYMMETRIC FLOATING WIND TURBINE INSTALLATION

(71) Applicant: EQUINOR ENERGY AS, Stavanager (NO)

(72) Inventor: Bjørn SKAARE, Trondheim (NO)

(21) Appl. No.: 18/864,630

(22) PCT Filed: May 12, 2023
(86) PCT No.: PCT/NO2023/050111

§ 371 Date: Nov. 11, 2024

(30) Foreign Application Priority Data
May 13, 2022 (GB) 2207053.6

(51) Int. Cl. B63B 35/44; B63B 1/10; B63B 21/50; F03D 13/25

(52) U.S. Cl. CPC B63B 35/44; B63B 1/107; B63B 21/50; F03D 13/256; B63B 2021/505; B63B 2035/446; F05B 2240/93; F05B 2240/95

(57) ABSTRACT

A floating wind turbine installation including an asymmetric floating wind turbine structure that is tethered to the floor of a body of water by a mooring system. The floating wind turbine structure includes a wind turbine mounted on a semi-submersible floating platform, and is oriented such that the wind turbine is positioned on an upwind side of the centre of mass of the floating wind turbine structure when the wind approaches the wind turbine structure in the direction of the prevailing wind at the location of the wind turbine installation.

The present invention relates to the field of floating wind turbines. In particular, it relates to a mooring configuration for an asymmetric floating wind turbine installation.

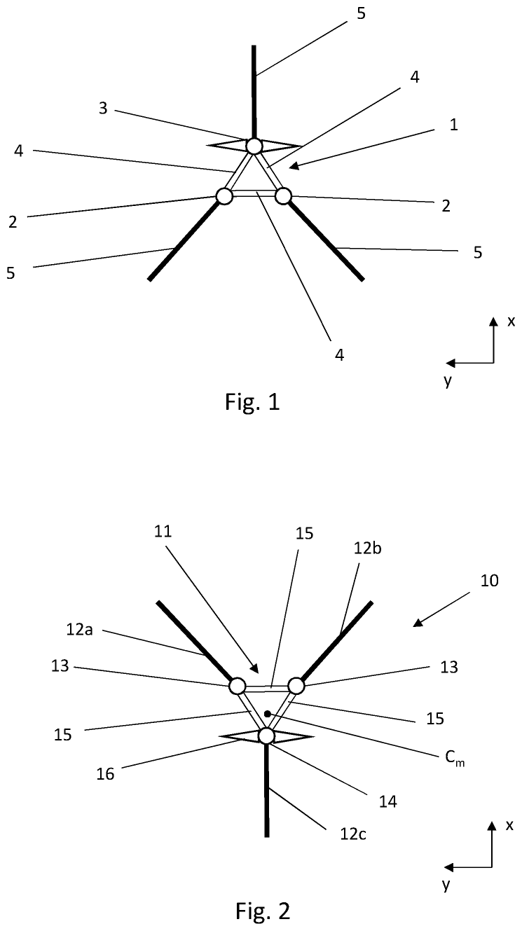

FIG. 1 is a schematic plan of a rotationally asymmetric semi-submersible floating wind turbine installation 1 that is moored to the sea floor in a known configuration. The wind turbine installation 1 comprises a semi-submersible floating platform with three columns: two empty columns 2 and a third column 3 supporting the wind turbine itself. The three columns 2, 3 are joined in a triangular ring configuration by three connecting members 4 to form the platform. The wind turbine installation is moored to the sea floor using three mooring lines 5, with one mooring line 5 being directly connected to each column 2, 3.

At the location of the wind turbine installation 1, the prevailing wind propagates in the positive direction along the x-axis indicated in FIG. 1. This is the direction in which the wind at the location of the wind turbine most commonly propagates. The wind turbine installation 1 of FIG. 1 is oriented such that column 3 (i.e. the column supporting the wind turbine) is situated on the downwind side of the installation 1 in the direction of the prevailing wind, with the empty columns 2 being positioned on the upwind side of the installation 1. The mooring lines 5 act to hold the wind turbine installation 1 in this orientation by resisting yawing motion of the wind turbine installation 1.

Compared to other orientations, the configuration shown in FIG. 1 provides a floating wind turbine installation 1 with favourable motion characteristics. For an asymmetric floating wind turbine installation, such as the one illustrated in FIG. 1, the force of the wind acting on the installation will produce a yawing moment that tends to turn the installation towards an orientation in which the column supporting the wind turbine is positioned at the downwind side of the installation. This is known as “weathervaning”. It will be appreciated that the installation 1 of FIG. 1 is oriented so that it is at its equilibrium position when the wind approaches the installation along the prevailing wind direction (i.e. in the positive x-direction). In which case no yawing moment will be generated. Since the wind will most commonly propagate in the direction of the prevailing wind, the installation 1 will be at or close to its equilibrium position for a majority of the time. Any change in wind direction away from the prevailing wind direction is likely to be small, and result in a relatively small yawing moment away from the position shown in FIG. 1. Hence, the installation 1 of FIG. 1 is oriented at a stable equilibrium position.

The arrangement of the mooring lines 5 illustrated in FIG. 1 is also favourable. The restoring yaw stiffness of the mooring line arrangement (i.e. the resistance provided by the mooring lines 5 against yawing) is at its greatest when the wind approaches the installation 1 directly between two adjacent mooring lines and is at its lowest when the wind approaches directly above a single mooring line. Hence, the mooring line arrangement illustrated in FIG. 1 provides optimum restoring yaw stiffness for the most common wind conditions at the installation site, which will see wind approaching along or close to the prevailing wind direction.

It will therefore be appreciated that the installation 1 illustrated in FIG. 1 will be relatively stable in yaw in the most common wind conditions observed at the installation site.

However, this orientation does not provide optimum conditions for power production. This is because, during operation, the thrust force of the prevailing wind acting on the wind turbine installation 1 will cause the structure to pitch (i.e. to rotate about its transverse axis) with the upwind side of the wind turbine installation 1 (i.e. columns 2) being forced to float higher in the water while the downwind side (i.e. column 3) is forced lower into the water. This reduces the height of the wind turbine above the water and causes the wind turbine to interact with wind at a lower altitude, which typically has a lower mean speed than wind at higher altitudes. As a result, the power output of the wind turbine is reduced.

According to a first aspect of the invention, there is provided a floating wind turbine installation, comprising an asymmetric floating wind turbine structure tethered to the floor of a body of water by a mooring system, wherein: the floating wind turbine structure comprises a wind turbine mounted on a semi-submersible floating platform, and the floating wind turbine structure is held in position by the mooring system such that the wind turbine is positioned on an upwind side of the centre of mass of the floating wind turbine structure in the direction of the prevailing wind at the location of the wind turbine installation.

Considered another way, the present invention may be seen as providing a floating wind turbine installation, comprising an asymmetric floating wind turbine structure tethered to the floor of a body of water by a mooring system, wherein the floating wind turbine structure comprises a wind turbine mounted on a semi-submersible floating platform, the floating wind turbine structure being oriented such that the wind turbine is positioned on an upwind side of the centre of mass of the floating wind turbine structure when the wind approaches the wind turbine structure in the direction of the prevailing wind at the location of the wind turbine installation.

The direction of the prevailing wind at the location of the wind turbine installation is the direction in which the wind predominantly propagates at the location of the wind turbine installation. It will be appreciated that the direction of the wind will likely vary over time, and hence that the wind will not constantly blow in the same, prevailing direction. However, the prevailing wind direction is the most common direction in which the wind blows at the location of the wind turbine installation. The wind may deviate from the prevailing direction locally, e.g. due to obstructions and/or local topography, although on a macro scale the wind will tend to propagate in the prevailing direction.

The reference to the floating wind turbine structure being asymmetric means that the floating wind turbine structure is rotationally asymmetric about a vertical axis, for example a vertical axis that passes through a central point of the floating wind turbine structure (i.e. the central point of the floating wind turbine structure when viewed in a horizontal plane, e.g. from above). This may be achieved by positioning the wind turbine away from the central point of the floating platform (i.e. at a non-central location of the floating platform) when viewed in a horizontal plane.

The mooring system is provided to maintain the floating wind turbine structure at its installation location, and in particular acts to maintain the intended orientation of the floating wind turbine structure, e.g. relative to the direction of the prevailing wind, by resisting yawing of the floating wind turbine structure. However, the mooring system may allow for some (relatively small) movements of the floating wind turbine structure, such as those that may be caused by the wind, currents and/or waves, whilst maintaining the wind turbine on an upwind side of the floating wind turbine structure in the direction of the prevailing wind. For instance, the floating wind turbine structure is able to pitch about its transverse axis e.g. due to a thrust force exerted on the floating wind turbine structure by the wind.

During operation, wind forces acting on the floating wind turbine installation will cause the floating wind turbine structure to pitch (i.e. rotate) about a transverse (i.e. side-to-side) axis passing through its centre of mass. When the floating wind turbine structure pitches part of the floating structure will be caused to sink lower into the water whilst another part is caused to rise out of the water. When the wind blows in the prevailing direction, the thrust force imparted on the floating wind turbine structure by the wind will cause the upwind side of the floating structure to rise further above the water line whilst causing the downwind side of the floating structure to sink lower below the water line. Since the wind turbine is situated upwind of the centre of mass of the floating wind turbine structure then this pitching motion of the floating wind turbine structure will cause the wind turbine to rise up, effectively increasing the height of the wind turbine above the level of the water. As a result, the wind turbine will interact with wind at a higher altitude above the water level, which typically has a higher mean wind speed than wind at lower altitudes. This can lead to an increase in the power production of the wind turbine. It has been found that positioning the wind turbine at an upwind side of the floating wind turbine structure may lead to an increase of up to 2% (e.g. 1% to 1.5%) in the annual power production of the wind turbine compared to conventional floating wind turbine structures which have the wind turbine located on their downwind side (e.g. as shown in FIG. 1). This could lead to as much as a 20% increase in profit margins, for example.

The pitch angle of the floating wind turbine structure will tend to vary around an average value over time as a result of dynamic motions due to, for example, the effect of waves and/or current on the floating structure. In general, the average pitch angle will be larger when wind forces act on the floating wind turbine structure compared to when there is no wind loading on the wind turbine. At rated wind speed the average pitch angle of the floating wind turbine structure may be between 6° to 14° (relative to the vertical).

Preferably, the wind turbine may be positioned (substantially) directly upwind of the centre of mass of the floating wind turbine structure in the direction of the prevailing wind. That is, an angle formed between the prevailing wind direction and a straight line passing through the position of the wind turbine and the centre of mass of the floating wind turbine installation may be 0°, or substantially (+/−5°) 0°. For a given thrust force, this orientation will maximise the increase in the height of the wind turbine that is achieved at the average pitch angle. This will typically lead to the greatest increase in the power output by the wind turbine. However, an increased power output may still be achieved when an angle of up to 60° is formed between the prevailing wind direction and a straight line passing through the position of the wind turbine and the centre of mass of the floating wind turbine installation. Hence, the angle formed between the prevailing wind direction and a straight line passing through the position of the wind turbine and the centre of mass of the floating wind turbine installation may be up to 60°, preferably up to 45°, more preferably up to 30°.

The semi-submersible platform may comprise a plurality of columns (e.g. three) connected by connecting members (e.g. in a triangular ring configuration). The connecting members may all be the same length. Hence, where the semi-submersible platform comprises three columns the columns may be connected in an equilateral triangle shape.

The wind turbine is preferably supported by, e.g. mounted on, one of the columns. The other of the plurality of columns may be empty, i.e. only one of the columns may support a wind turbine.

The separation between adjacent columns may be between 50 m and 100 m, preferably between 70 m and 80 m. Hence, the connecting members may have a length of between 50 m and 100 m, preferably between 70 m and 80 m.

Since pitching is a rotational motion about a transverse axis, it will be appreciated that the achievable increase in the height of the wind turbine (caused by pitching) will be proportional to the distance between the transverse axis of the floating offshore wind turbine structure and the location of the wind turbine. Hence, the larger this distance, the greater the achievable height increase. The distance between the centre of gravity of the floating wind turbine structure and the position of the wind turbine can be affected by the spacing between the columns, and hence the length of the connecting members. Thus, longer connecting members may provide for a greater achievable increase in the height of the wind turbine and therefore a greater increase in power production.

Each column may have a circular cross section, i.e. be formed as a cylindrical column, or have a polygonal cross-section. That is, each column may be formed as a multi-sided (e.g. triangle, square, trapezoid, pentagon, etc.) column.

The columns may have a diameter between 10 m and 20 m, preferably between 14 m and 16 m.

One or more or each of the columns may comprise or define a ballast tank for storing air and/or ballast. Ballast, such as water, may be held within one or more of the ballast tanks. For instance, ballast may be distributed amongst the ballast tanks such that the floating wind turbine structure maintains a heel angle of 0° or substantially 0° (i.e. within +/−5°) when there is no wind loading on the wind turbine (i.e. in non-wind conditions). To achieve this, the mass of the ballast within the ballast tank on which the wind turbine is supported may be less than the mass of the ballast within the ballast tanks of the other columns.

The semi-submersible platform may comprise one or more pontoons that extend between two of the plurality of columns, e.g. two adjacent columns. Each column may be connected to an adjacent column via a pontoon. The pontoons may be hollow and define a ballast tank for holding air and/or ballast. During operation of the floating wind turbine installation, the pontoons may be located below the waterline. The pontoons can act to dampen movement of the floating wind turbine structure during use, and may also be used to provide the necessary buoyancy required during installation of the floating wind turbine structure.

The semi-submersible platform may employ passive ballasting, i.e. the ballast within each column and/or pontoon may remain constant during operation. Alternatively, the semi-submersible platform may comprise an active ballast system for altering the amount and the mass of ballast held within one or more of the ballast tanks (e.g. of the columns and/or pontoons) during use. The active ballast system may comprise one or more pumps for pumping liquid ballast (e.g. water) into and/or out of the ballast tanks (e.g. of the columns and/or pontoons).

Ballast may be distributed between the ballast tanks of the columns and/or the ballast tanks of the pontoons such that when the wind turbine is operating at rated wind speed, the average pitch angle of the floating wind turbine structure is between 6° to 14°.

When the wind turbine is mounted on the semi-submersible platform (and optionally when the platform is ballasted), the columns may extend up to 20 m above the waterline.

The wind turbine may comprise a tower and a rotor mounted at an upper end of the tower, preferably for rotation about a horizontal axis. The tower may have a length (i.e. a height) of at least 75 m, preferably more than 100 m, and more preferably more than 130 m. The tower may be mounted on one of the columns of the semi-submersible floating platform.

The rotor may comprise a hub and a plurality of, preferably three, blades mounted to the hub.

The wind turbine is preferably a horizontal-axis wind turbine, i.e. the rotor is arranged to, in use, rotate about a substantially horizontal axis.

It will be appreciated that when the floating wind turbine structure pitches as a result of the trust force imparted on the floating structure by the prevailing wind, the rotor of the wind turbine will be positioned higher above the water and will hence interact with wind that typically has a higher mean wind speed than wind at lower altitudes. This can result in an increase in the power output of the wind turbine.

The blades may have a length of at least 75 m, preferably 100 m or more, and more preferably 130 m or more.

The turbine may comprise a nacelle mounted at the upper end of the tower. The rotor may be mounted to the nacelle, e.g. via the hub, and arranged to rotate with respect to the nacelle.

The nacelle is preferably mounted rotatably to the tower so as to permit rotation of the nacelle with respect to the tower about the longitudinal axis of the tower. In this way, the rotor may be yawed into oncoming wind.

The turbine may comprise a generator coupled to the rotor to generate electrical power through rotation of the rotor. The generator may be mounted in the nacelle.

The wind turbine may have a rated power output of greater than 10 MW, preferably greater than 15 MW, most preferably greater than 20 MW. The wind turbine may have a rated power output of between 15 MW and 23 MW.

The mooring system may comprise a plurality of (e.g. three or more) mooring lines connected, directly or indirectly, to the floating wind turbine structure. In order to tether the floating wind turbine installation to the floor of the body of water, each mooring line may be anchored at one end (i.e. the anchor end) to the floor of the body of water, and connected at the other end (i.e. the connection end) to the floating wind turbine structure.

The length of the mooring lines will depend on the location of the floating wind turbine installation and the depth of the water. However, typically, the mooring lines may have a length of between 800 m and 900 m.

One or more or each of the mooring lines may be anchored to the floor of the body of water by an anchor chain. One end of the anchor chain may be connected to the anchor end of a mooring line and the other end of the anchor chain may be anchored to the floor of the body of water. The anchor chain(s) may have a length of between 20 m and 40 m.

One or more or each of the mooring lines may be connected to the floating wind turbine structure via or with a bridle. The bridle may comprise two or more bridle lines for connecting an end of a mooring line to the floating wind turbine installation. Each bridle may be connected at a first end thereof to one end of (i.e. the connection end) of a mooring line and connected at its second end to the floating wind turbine installation (e.g. to the semi-submersible platform).

The two or more bridle lines of a bridle may have a length of between 75 m and 125 m.

The two or more bridle lines of a bridle may be connected to the floating wind turbine installation at two or more different (spaced apart) locations or connection points. For instance, the bridle may connect a single mooring line to more than one (e.g. two or more) column of the semi-submersible platform. In some arrangements, the two or more bridle lines may each be connected to a different one of the columns.

Two or more bridle lines of different bridles may be connected to the floating wind turbine installation at the same, common connection point.

The mooring lines may be connected to the floating wind turbine structure (e.g. to the semi-submersible platform) above the water line, or below the water line, e.g. at the lower end of the semi-submersible platform.

Using one or more bridles to attach the mooring lines to the floating wind turbine structure can help to stabilise the floating structure in roll and yaw. Provision of the bridles significantly increases the yaw restoring stiffness of the mooring system compared to an arrangement where the mooring lines are directly connected to the floating platform (e.g. as shown in FIGS. 1 and 2) when the pre-tension is otherwise the same. This can lead to a reduction in yaw motion, and also a reduction in roll motion since there will be less coupling from pitch motion when yaw motion is reduced. A similar increase in the restoring yaw stiffness could be achieved for a mooring system in which the mooring lines are directly connected to the floating structure by increasing the pre-tension in the mooring lines. However, this would increase the mooring line loads, which could lead to increased mooring line fatigue and a reduction in the lifetime of the mooring lines.

In one arrangement, the semi-submersible platform comprises three columns (e.g. arranged in a triangular ring configuration) and the mooring system comprises three mooring lines. Each mooring line of the three mooring lines may be connected to the floating wind turbine structure by a respective bridle comprising two bridle lines, with each bridle line being connected to a different one of the columns of the semi-submersible platform. In this way, the respective mooring line can be connected to two columns via the bridle. Each of the columns of the semi-submersible platform may be (indirectly) connected to two of the mooring lines via (respective) bridle lines.

In an alternative arrangement, the semi-submersible platform may comprise three columns (e.g. arranged in a triangular ring configuration), with the wind turbine mounted on one of the columns, and the mooring system may comprise four mooring lines. Each mooring line may be connected directly to the floating wind turbine structure. Two mooring lines of the four mooring lines may be connected to the column supporting the wind turbine, e.g. at the same connection point. These two mooring lines may each be offset from the prevailing wind direction by up to 30°, and separated from each other by up to 60°. That is, this pair of mooring lines may straddle the prevailing wind direction, with one of the mooring lines arranged up to 30° from the prevailing wind direction in a clockwise direction and the other one of the mooring lines arranged up to 30° from the prevailing wind direction in an anti-clockwise direction. The other two mooring lines may be respectively connected to a different one of the other columns. Hence, the column supporting the wind turbine may be connected to two mooring lines, and the other two columns if the three columns may each be connected to a respective single mooring line. This arrangement may provide an increased yaw restoring stiffness from the mooring system compared to the arrangement shown in FIG. 1, similar to using bridles as discussed above. However, compared to using bridles, this arrangement is more complex and is likely to be more costly.

In the above arrangement, the mooring system may comprise one or more additional mooring lines connected to the columns. One or more of the two other columns (i.e. the columns not supporting the wind turbine) may be connected (e.g. directly) to one or more of the additional mooring lines. Both of the two other columns may be connected to a respective additional mooring line (or a plurality of additional mooring lines). Hence, one or both of the other columns may be connected to two or more mooring lines.

In yet another arrangement, the semi-submersible platform may comprise three columns (e.g. arranged in a triangular ring configuration), with the wind turbine mounted on one of the columns, and the mooring system may comprise three mooring lines. Two of the three mooring lines may be connected (e.g. directly) to the column supporting the wind turbine, e.g. at the same connection point. These two mooring lines may each be offset from the prevailing wind direction by up to 30°, and separated from each other by up to 60°. That is, this pair of mooring lines may straddle the prevailing wind direction, with one of the mooring lines arranged up to 30° from the prevailing wind direction in a clockwise direction and the other one of the mooring lines arranged up to 30° from the prevailing wind direction in an anti-clockwise direction. The other mooring line of the three mooring lines may be connected to both of the two other columns of the three columns via or with a bridle. The other mooring line of the three mooring lines may be connected to the floating wind turbine structure by a bridle comprising two bridle lines. Each bridle line may be connected to a different one of the other two columns of the semi-submersible platform (i.e. the columns not supporting the wind turbine). In this way, the other mooring line of the three mooring lines can be connected to the two other columns via the bridle. This arrangement has been found to provide an increased yaw restoring stiffness from the mooring system compared to the arrangement shown in FIG. 1, similar to the arrangements discussed above.

The mooring lines may be arranged evenly spaced about the floating wind turbine structure. For example, they mooring lines may be spaced apart at angles of 120° around the floating wind turbine structure.

The mooring system may be asymmetric. By this, it is meant that the mooring system is rotationally asymmetric about a vertical axis (e.g. through a central point of the mooring system) when viewed in a horizontal plane. This may be achieved by having mooring lines that are connected to the floating wind turbine installation using bridles of different lengths. For instance, the mooring system may comprise two mooring lines that are connected to the floating wind turbine installation by bridles having a first length, and a third mooring line that is connected to the floating wind turbine installation by a bridle having a second length that is shorter than the first length. The two mooring lines may be connected (by at least one bridle line of the respective bridle) to the column of the semi-submersible platform on which the wind turbine is supported. The third mooring line may not be connected to the column on which the wind turbine is mounted.

Compared to a symmetric mooring system, an asymmetric mooring system may provide a more stable system by providing improved support for the floating wind turbine structure when the wind is blowing in the prevailing direction. This may prevent undesirable motion of the floating wind turbine installation and help to prevent undesirably large loads on the floating wind turbine installation and the mooring system.

One or more or all of the mooring lines (and, where present, the bridles) may be arranged as a catenary. Hence, the mooring lines may be catenary mooring lines.

The bridle lines and the mooring lines may be made of any suitable material, such as chains, wires (e.g. steel wires) or fibre rope (e.g. polyester rope) or combinations thereof. The bridle lines and the mooring lines may be made of the same material, or different materials.

The bridle lines may be connected to the mooring lines with a joint, such as a vacuum-explosion welded transition joint.

The mooring lines and/or the bridle lines may be connected to the floating wind turbine installation with a connector, such as a fairlead.

One or more or all of the mooring lines may be connected to a clump weight and/or a buoy. The clump weight and/or the buoy may be connected to the mooring line between its anchor end and its connection end. This will provide additional tension in the mooring lines.

The floating wind turbine installation is preferably located offshore, i.e. located at sea. Hence, the floating wind turbine installation may be tethered to the sea floor by the mooring system. However, the floating wind turbine installation may be located in any other suitable body of water, for example in a lake, river, or the like.

According to another aspect of the invention, there is provided a method of mooring an asymmetric floating wind turbine structure in a body of water, wherein the floating wind turbine structure comprises a wind turbine mounted on a semi-submersible floating platform, the method comprising: tethering the floating wind turbine structure to the floor of the body of water using a mooring system such that the floating wind turbine structure is held in position by the mooring system with the wind turbine positioned on an upwind side of the centre of mass of the floating wind turbine structure in the direction of the prevailing wind at the location of the floating wind turbine structure.

Considered another way, the present invention may be seen as providing a method of mooring an asymmetric floating wind turbine structure in a body of water, wherein the floating wind turbine structure comprises a wind turbine mounted on a semi-submersible floating platform, the method comprising: tethering the floating wind turbine structure to the floor of the body of water using a mooring system such that the wind turbine is positioned on an upwind side of the centre of mass of the floating wind turbine structure when the wind approaches the wind turbine structure in the direction of the prevailing wind at the location of the floating wind turbine structure.

In such a method, the floating wind turbine structure and/or the mooring system may be as described above, and may include one or more or all of their preferred or optional features. Hence, the floating wind turbine structure and the mooring system may form a floating wind turbine installation as described above, with any of its optional features.

Certain preferred embodiments of the present invention will now be described in greater detail by way of example only and with reference to the accompanying drawings, in which:

FIG. 1 is a schematic plan view of a floating wind turbine installation in a known orientation;

FIG. 2 is a schematic plan view of an alternative floating wind turbine installation;

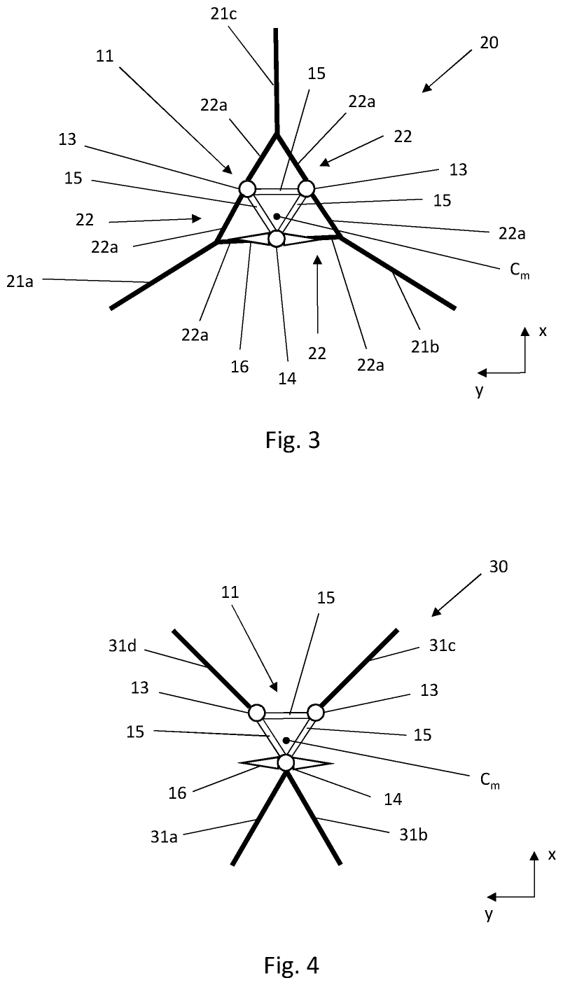

FIG. 3 is schematic plan view of another floating wind turbine installation;

FIG. 4 is a schematic plan view of another floating wind turbine installation;

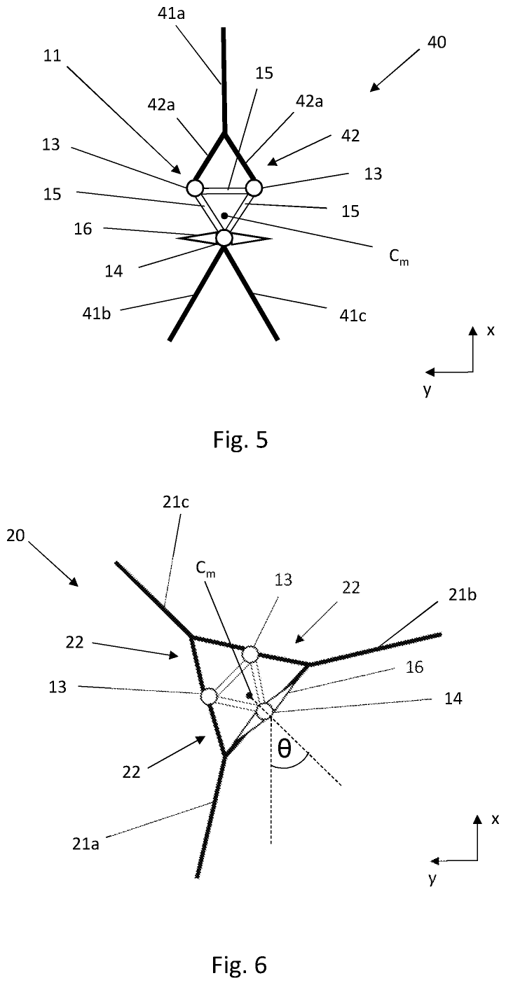

FIG. 5 is a schematic plan view of yet another floating wind turbine installation;

FIG. 6 is a schematic plan view of the wind turbine installation of FIG. 3 arranged at an angle with respect to the direction of the prevailing wind;

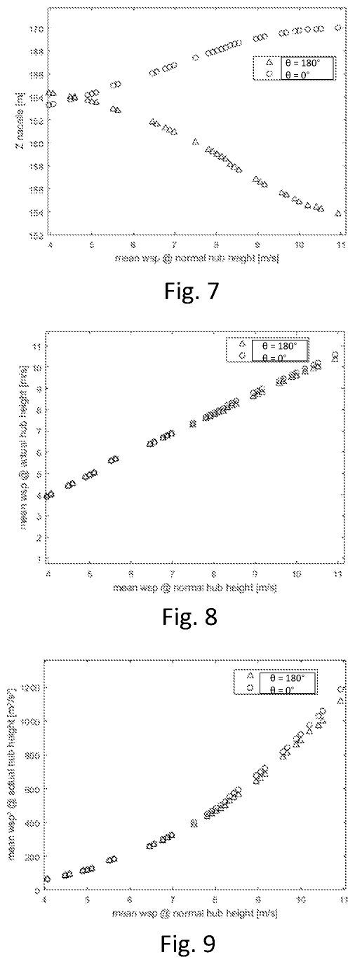

FIG. 7 is a graph showing the average height above the water of the nacelle of a wind turbine installation as a function of wind speed, for wind approaching from different directions;

FIG. 8 is a graph showing the average wind speed at the actual height of the nacelle of a wind turbine installation as a function of the average wind speed at the height of the nacelle in non-wind conditions, for wind approaching from different directions;

FIG. 9 is a graph indicating the available wind energy at the actual height of the nacelle of a wind turbine installation as a function of the average wind speed at the height of the nacelle in non-wind conditions, for wind approaching from different directions;

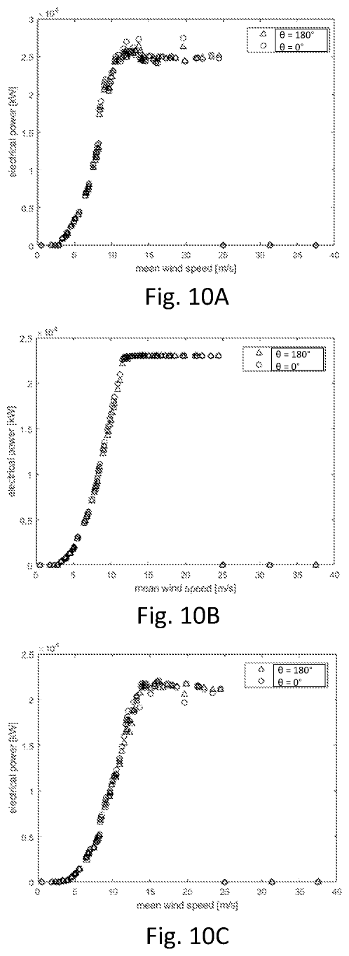

FIGS. 10A-10C are graphs showing the electrical power production for a wind turbine installation as a function of average wind speed, for wind approaching from different directions;

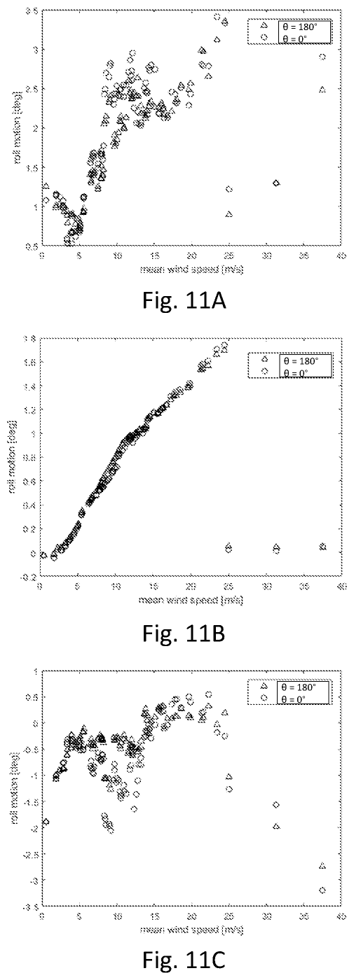

FIGS. 11A-11C are graphs showing the roll motion response for a wind turbine installation as a function of average wind speed, for wind approaching from different directions;

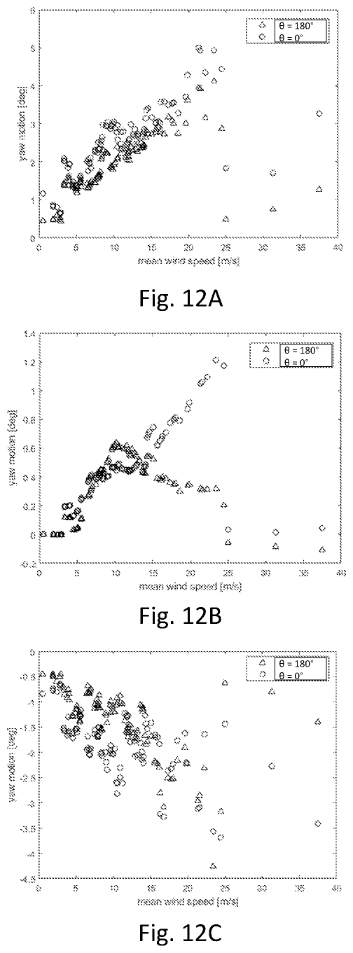

FIGS. 12A-12C are graphs showing the yaw motion response for a wind turbine installation as a function of average wind speed, for wind approaching from different directions;

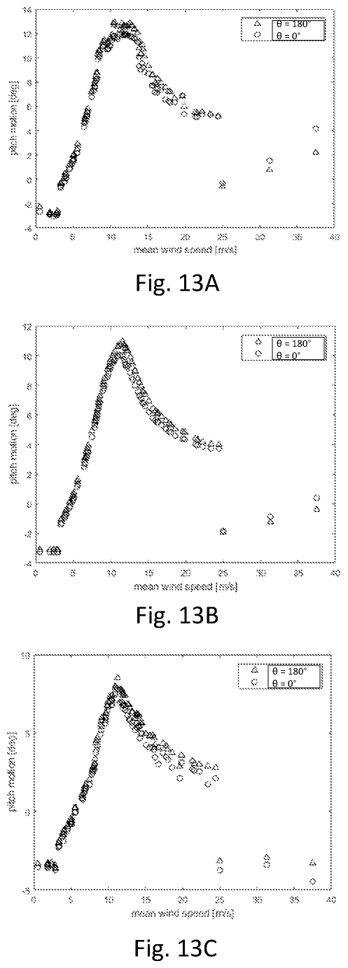

FIGS. 13A-C are graphs showing the pitch motion response for a wind turbine installation as a function of average wind speed, for wind approaching from different directions; and

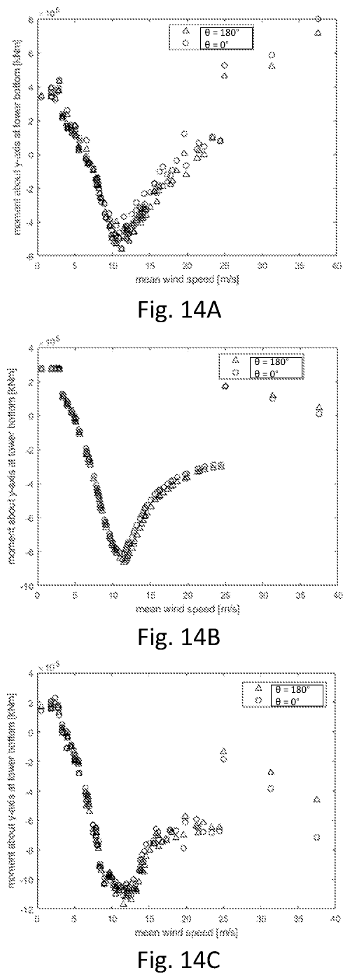

FIGS. 14A-C are graphs showing the tower bottom bending moment for a wind turbine installation as a function of average wind speed, for wind approaching from different directions.

The known wind turbine installation of FIG. 1 has been discussed above. FIG. 2 is a schematic plan of a proposed floating wind turbine installation 10 comprising an asymmetric floating wind turbine structure 11 that is held in position by three mooring lines 12a, 12b, 12c anchored to the sea floor. The floating wind turbine structure 11 includes a semi-submersible floating platform formed of three columns 13, 14 joined in a triangular ring configuration by three connecting members 15. Two of the columns 13 are empty (i.e. they do not support a wind turbine) whilst the third column 14 supports a wind turbine 16. The wind turbine 16 is a conventional horizontal-axis wind turbine and includes tower which supports a nacelle. The nacelle houses a generator and supports a rotor comprising a plurality, e.g. three, rotor blades. The tower is supported in a substantially upright orientation by the semi-submersible platform.

Each mooring line 12a, 12b, 12c is connected directly to the floating wind turbine structure 11 (specifically to a column 13, 14 of the floating wind turbine structure 11).

The columns 13, 14 comprise ballast tanks for containing air and ballast, such as water. Ballast may be added to and/or removed from the columns 13, 14 in order to achieve a near 0° angle of heel in non-wind conditions. To achieve this, column 14 supporting the wind turbine 16 may be predominantly filled with air. The floating wind turbine structure 11 may include one or more pumps to add and/or remove liquid ballast (e.g. sea water) to and from the ballast tanks.

As in FIG. 1, the prevailing wind at the location of the floating wind turbine installation 10 propagates along the positive x-axis, as shown in FIG. 2. The floating wind turbine structure 11 is oriented such that the column 14 on which the wind turbine 16 is mounted is on the upwind side of the floating wind turbine structure 11 in the direction of the prevailing wind. Specifically, the column 14 supporting the wind turbine 16 is positioned such that it is on an upwind side of the centre of mass Cₘ of the floating wind turbine structure 11 when the wind approaches the wind turbine installation 10 in the direction of the prevailing wind (i.e. along the positive x-axis shown in FIG. 2). The mooring lines 12a, 12b, 12c provide resistance against yawing of the floating wind turbine structure 11 so as to maintain the wind turbine 16 on the upwind side of the wind turbine structure 11 in the direction of the prevailing wind. Whilst the floating wind turbine structure 11 may experience (relatively small) yawing motions (e.g. due to the effect of wind forces, current and/or waves on the wind turbine structure 11), the mooring lines 12a, 12b, 12c act to maintain the wind turbine structure 11 (substantially) in the desired orientation.

As discussed above, a wind thrust force acting on the floating wind turbine structure 11 will cause the floating wind turbine structure 11 to pitch about a transverse axis (i.e. side to side axis) passing through its centre of mass Cₘ. With the orientation shown in FIG. 2, the pitching motion of the floating wind turbine structure 11 due to a wind thrust force acting in the direction of the prevailing wind will cause the columns 13 situated on the downwind side of the centre of mass Cₘ to sink lower into the water and will cause the column 14 (supporting the wind turbine 16) on the upwind side of the centre of mass Cₘ to float higher in the water. As a result, the average height of the wind turbine 16 (and the rotor of the wind turbine 16) above the water will be increased, causing the rotor of the wind turbine 16 to interact with wind at a higher altitude. This increase in average height can lead to an increase in the power output by the wind turbine 16. This is because the speed of the wind (and its kinetic energy) is typically greater at higher altitudes, meaning more energy can be extracted from the wind by the wind turbine 16 and converted into electrical power.

Whilst the floating wind turbine installation 10 shown in FIG. 2 provides benefits in terms of increased power production, it may suffer from undesirable motion characteristics and increased loading on the mooring lines 12a-c and other components of the floating wind turbine installation 10.

When the wind approaches the floating wind turbine structure 11 along the prevailing wind direction (i.e. the positive x-axis of FIG. 2) then no yawing moment will be generated by the wind forces acting on the structure 11. Thus, the arrangement shown in FIG. 2 is oriented at an equilibrium position when the wind approaches along the prevailing wind direction. However, this is an unstable equilibrium position. Due to the weathervaning effect discussed above, when the wind approaches the floating wind turbine structure 11 away from the direction of the prevailing wind, a yawing moment will be generated that forces the structure 11 to yaw towards an orientation in which the column 14 supporting the wind turbine 16 is positioned on the downwind side of the installation. Even small changes in the wind direction away from the prevailing wind direction will result in a relatively large yawing moment (e.g. compared to the typical yawing moments generated in the floating wind turbine installation shown in FIG. 1) because the moment arm between the wind thrust force and the centre of mass Cₘ of the floating structure 11 is large.

Moreover, since the wind will most commonly approach along or close to the prevailing wind direction, the wind will typically approach the floating wind turbine structure 11 above single mooring line 12c. In this case, the restoring yaw stiffness of the mooring system will be at its lowest and the mooring system will be less able to counter the weathervaning yaw motion.

Also, when the wind approaches the wind turbine structure 11 over a single mooring line (e.g. mooring line 12c) a substantial fraction of the loading will be applied to that mooring line, whereas when the wind approaches between two adjacent mooring lines the loading will be distributed between the two mooring lines. Hence, the loading on each mooring line will be less when the wind approaches between two adjacent mooring lines. As a result, when the wind approaches over a single mooring line, that mooring line will experience greater loading and increased fatigue. This may shorten the lifetime of the mooring line.

An alternative wind turbine installation 20 designed at least in part to reduce these issues is shown in FIG. 3.

The floating wind turbine installation 20 of FIG. 3 includes a floating wind turbine structure 11 that is predominantly the same as the one described above in respect of FIG. 2. It includes a semi-submersible floating platform formed of three columns 13, 14 joined in a triangular ring configuration by three connecting members 15, with a wind turbine 16 being supported by one of the columns 14. Similar to the floating wind turbine installation 10 of FIG. 2, the floating wind turbine installation 20 is oriented such that the column 14 supporting the wind turbine 16 is positioned at an upwind side of the centre of mass Cₘ of the floating wind turbine structure 11 when the wind approaches the wind turbine installation 20 in the direction of the prevailing wind (i.e. along the positive x-axis shown in FIG. 3).

In FIG. 3, the floating wind turbine structure 11 is held in position with a mooring system comprising three mooring lines 21a, 21b, 21c and three bridles 22. Each of the mooring lines 21a, 21b, 21c is connected to the floating wind turbine structure 11 (specifically the columns 13, 14 of the floating wind turbine structure 11) via a respective bridle 22. Hence, the mooring system comprises three mooring lines 21a-c that are each connected to the floating wind turbine structure via a respective bridle 22.

As with the arrangement discussed above, the mooring lines 21a, 21b, 21c provide resistance against yawing of the floating wind turbine structure 11 so as to maintain the wind turbine 16 on the upwind side of the wind turbine structure 11 in the direction of the prevailing wind.

Each bridle 22 comprises two bridle lines 22a. In each bridle 22, one bridle line 22a is connected to one of the columns 13, 14, and the other bridle 22a is connected to another one of the columns 13, 14 (i.e. a different column 13, 14). Hence, each mooring line 21a-c is connected to two different columns 13, 14 via a bridle 22.

Mooring line 21a is connected to the column 14 supporting the wind turbine 16 via one bridle line 22a and is connected to an empty column 13 via another bridle line 22a. Mooring line 21b is connected to the column 14 supporting the wind turbine 16 via one bridle line 22a and is connected to a (different) empty column 13 via another bridle line 22a. Mooring line 21c is connected to an empty column 13 via one bridle line 22a and is connected to a (different) empty column 13 via another bridle line 22a. Hence, each column 13, 14 is connected to two mooring lines 21a-c via respective bridle lines 22a.

The presence of the bridles provides the wind turbine installation 20 with more favourable motion characteristics compared to the mooring system shown in FIG. 2.

By connecting the mooring lines 21a-c to the floating wind turbine structure 11 via the bridles 22, for a given pre-tension the yaw restoring stiffness of the mooring system is significantly increased compared to the mooring systems shown in FIGS. 1 and 2. Moreover, due to the orientation of the mooring lines 21a-c the restoring yaw stiffness of the mooring system is greatest when the wind approaches the floating wind turbine structure 11 along the prevailing wind direction (i.e. along the positive x-axis). As discussed above, the restoring yaw stiffness of the mooring system is greatest when wind approaches between two adjacent mooring lines, which will occur for the installation 20 illustrated in FIG. 3 when the wind approaches along the prevailing wind direction.

Since the floating wind turbine installation 20 shown in FIG. 3 is oriented with the column 14 that supports the wind turbine 16 at an upwind side of the floating platform, the floating wind turbine installation 20 benefits from increased power production much like the wind turbine installation 10 shown in FIG. 2. The thrust force exerted on the floating wind turbine structure 11 by wind blowing in the prevailing wind direction (i.e. along the positive x-axis as shown in FIG. 3) will cause the floating wind turbine structure 11 to pitch about a transverse axis passing through its centre of mass Cₘ. This will cause the columns 13 located on the downwind side of the installation 20 to sink lower into the water, and cause the column 14 supporting the wind turbine 16 to rise higher in the water. As a result, the rotor of the wind turbine 16 will be caused to interact with wind at a higher altitude which typically has higher mean speeds, leading to an increase in the power output by the wind turbine 16.

Another wind turbine installation 30 is shown in FIG. 4. The floating wind turbine installation 30 of FIG. 4 includes a floating wind turbine structure 11 that is predominantly the same as the one described above in respect of FIGS. 2 and 3, so is not described in detail here to avoid repetition. The floating wind turbine installation 30 is oriented such that the column 14 supporting the wind turbine 16 is positioned at an upwind side of the centre of mass Cₘ of the floating wind turbine structure 11 in the direction of the prevailing wind (i.e. along the positive x-axis shown in FIG. 4).

In the installation 30 of FIG. 4, the floating wind turbine structure 11 is held in position with a mooring system comprising four mooring lines 31a, 31b, 31c, 31d. The mooring lines 31a, 31b, 31c, 31d provide resistance against yawing of the floating wind turbine structure 11 so as to maintain the wind turbine 16 on the upwind side of the wind turbine structure 11 in the direction of the prevailing wind.

Each of the mooring lines 31a, 31b, 31c, 31d is connected directly to the floating wind turbine structure 11 (specifically to a column 13, 14 of the floating wind turbine structure 11), i.e. without bridles.

Two mooring lines 31a, 31b are directly connected to the column 14 supporting the wind turbine 16. Hence, column 14 is directly connected to two mooring lines 31a, 31b.

The two other mooring lines 31c, 31d are each respectively connected directly to an empty column 13 so that each empty column 13 is directly connected to one of the mooring lines 31c, 31d. That is, one mooring line 31c is connected to an empty column 13, and another mooring line 31d is connected to a different empty column 13.

The arrangement illustrated in FIG. 4 may provide an increased yaw restoring stiffness from the mooring system compared to the arrangement shown in FIG. 1.

Yet another wind turbine installation 40 is shown in FIG. 5. The floating wind turbine installation 40 of FIG. 5 includes a floating wind turbine structure 11 that is predominantly the same as the one described above in respect of FIGS. 2-4, so is not described in detail here to avoid repetition. The floating wind turbine installation 40 is oriented such that the column 14 supporting the wind turbine 16 is positioned at an upwind side of the centre of mass Cₘ of the floating wind turbine structure 11 in the direction of the prevailing wind (i.e. along the positive x-axis shown in FIG. 5).

In the installation 40 of FIG. 5, the floating wind turbine structure 11 is held in position with a mooring system comprising three mooring lines 41a, 41b, 41c and one bridle 42 which is connected to the mooring line 41a. The mooring lines 41a, 41b, 41c and the bridle 42 provide resistance against yawing of the floating wind turbine structure 11 so as to maintain the wind turbine 16 on the upwind side of the wind turbine structure 11 in the direction of the prevailing wind.

The mooring line 41a is connected to the wind turbine structure 11 via the bridle 42. The bridle comprises two bridle lines 42a. Each of the bridle lines 42a is connected to one of the two empty columns 13 such that one bridle line 42a is connected to each empty column 13.

The two further mooring lines 41b, 41c are connected directly to the column 14 supporting the wind turbine 16, such that column 14 is connected to two mooring lines 41b, 41c.

The mooring system of FIG. 5 provides improved yaw stiffness compared to the arrangement shown in FIG. 1.

The wind turbine installations 10, 20 shown in FIGS. 2-5 are oriented so that the column 14 supporting the wind turbine 16 is directly upwind of the centre of mass Cₘ of the floating wind turbine structure 11 in the direction of the prevailing wind (i.e. the positive x-axis shown in the Figures). That is, there is an angle θ of 0° between the prevailing wind direction and a straight line that passes through the centre of the wind turbine 16 and the centre of mass Cₘ. However, it has been found that an appreciable, although lesser, increase in the power output of the wind turbine 16 may still be achieved when the wind turbine installation 20 is oriented at an angle θ of up to +/−60° from the direction of the prevailing wind, i.e. when there is an angle θ of up to +/−60° between the prevailing wind direction and a straight line passing through the centre of the wind turbine 16 and the centre of mass Cₘ. FIG. 6 shows the wind turbine installation 20 of FIG. 3 oriented at an angle θ from the prevailing wind direction, which propagates along the positive x-axis shown in the Figure.

Although, with the orientation shown in FIG. 6, the increase in power output by the wind turbine may be reduced compared to when the column 14 supporting the wind turbine 16 is located directly upwind of the centre of mass Cₘ of the floating wind turbine structure 11 (as shown e.g. in FIG. 3), wind approaching the floating wind turbine installation 10 at an angle θ of up to +/−60° may still provide an adequate thrust force to cause the column 14 supporting the wind turbine 16 to rise higher in the water as a result of a pitching motion. This can lead to an increase in the power output by the wind turbine, as discussed above. Typically, a greater increase in the height of the wind turbine 16, and hence a greater increase in power output, will be achieved at smaller angles θ, for instance 45° or 30°.

The bridle lines 22a, 42a and the mooring lines 12a-c, 21a-c, 31a-d and 41a-c described above may be made of various materials including mooring chain, wire rope, polyester rope, etc. The bridle lines 22a, 42a and the mooring lines 12a-c, 21a-c, 31a-d and 41a-c may be made of the same materials or different materials. In some floating wind turbine installations 10, 20, 30, 40 the mooring lines 12a-c, 21a-c, 31a-d and 41a-c may be formed of a plurality of segments, which may comprise different materials.

The bridle lines 22a, 42a and the mooring lines 12a-c, 21a-c, 31a-d and 41a-c may have the same or different thicknesses.

The bridle lines 22a, 42a may be connected to the mooring lines 21a-c, 41a with a joint such as a vacuum-explosion welded transition joint, e.g. Triplate®.

The bridle lines 22a, 42a and/or the mooring lines 12a-c, 21a-c, 31a-d and 41a-c may be connected to the floating wind turbine structure 11 (e.g. the columns 13, 14 of the floating wind turbine structure 11) with a connector such as a fairlead.

Simulations have been carried out to compare the response of the floating wind turbine installation 20 of FIG. 3 when wind approaches at an angle θ of 0° to the response of the floating wind turbine installation 20 when the wind approaches at an angle θ of 180°. It will be appreciated that this provides a comparison between the response of the floating wind turbine installation 20 when the column 14 supporting the wind turbine 16 is positioned at the upwind side of the floating wind turbine structure 11 (e.g. as shown in FIG. 3) and the response of the floating wind turbine installation 20 when the column 14 supporting the wind turbine 16 is positioned at the downwind side of the floating wind turbine structure 11 (similar to the known orientation shown in FIG. 1).

The simulation data was obtained by modelling the motion characteristics of a floating wind turbine installation 20 having three columns 13, 14 that extend 18 m above the waterline, and a 23 MW wind turbine 16 having a 138 m tall tower and a rotor situated at the top of the tower and comprising three blades of 136 m in length. In this example, the connecting members 15 connecting the columns 13, 14 are each 77.45 m in length. The modelled system has bridle lines 22a that are each 100 m long and made of steel wire, and mooring lines 21a-c that are each 855 m in length and made of polyester rope. An anchor chain of 30 m length connects the end of each mooring line to the sea floor.

In the simulations, waves were assumed to approach the floating wind turbine installation 20 from the same direction as the wind.

A base case simulation study was performed using a wind shear profile exponent α of 0.14, as recommended by IEC standard 61400-1:2019. The study found that the annual power production of the wind turbine 16 was increased by 1.5% for the case where the wind approaches the wind turbine installation 20 at an angle θ of 0° compared to when the wind approaches the wind turbine installation 20 at an angle θ of 180°.

Another simulation study was performed using a wind shear profile exponent α of 0.10. This study also showed an increase in the annual power production of the wind turbine 16 for the case where the wind approaches the wind turbine installation 20 at an angle θ of 0° compared to when the wind approaches the wind turbine installation 20 at an angle θ of 180°. In this case, the increase in annular power production was 1.1%.

Selected results from the simulation study will now be described with reference to FIGS. 7-14.

FIG. 7 shows the simulated average height of the nacelle of the wind turbine 16 above the water compared to the wind speed at the height of the nacelle in non-wind conditions. The graph shows how the average height of the nacelle changes with increasing wind speed for the case where θ=0° and the case where θ=180°. It can be seen that when the wind approaches the floating wind turbine installation 20 at an angle θ of 0° the average height of the nacelle tends to increase as the wind speed increases. On the other hand, when the wind approaches the floating wind turbine at an angle of θ of 180° the height of the nacelle tends to decrease with increased wind speed. FIG. 7 shows that a difference in height of more than 16 m is seen at a wind speed of around 11 ms⁻¹ (+/−1 ms⁻¹), which is a typical rated wind speed for a wind turbine located in the North Sea.

Wind tends to propagate at different speeds at different altitudes, and is typically faster at higher altitudes. It will therefore be appreciated that the nacelle, and the rotor of the wind turbine 16, will interact with wind of differing speeds depending on its height above the water. FIG. 8 shows the simulated average wind speed at the (actual) height of the nacelle (i.e. the height at which the nacelle sits at the average pitch angle of the floating wind turbine structure 11 due to wind thrust effects) compared to the average wind speed at the (nominal) height of the nacelle in non-wind conditions. As can be seen, the average wind speed at the actual nacelle height when the wind approaches the floating wind turbine installation 20 at an angle θ of 0° is typically faster than the average wind speed at the actual nacelle height when the wind approaches the floating wind turbine installation 20 at an angle θ of 180°.

The amount of energy that can be extracted from the wind by a wind turbine is proportional to the cube of the wind speed. FIG. 9 shows how the cube of the simulated average wind speed (which is proportional to the available wind energy) at the actual nacelle height changes with the average wind speed at the nominal nacelle height. As can be seen, the cube of the average wind speed at the actual nacelle height, and thus the available wind energy, is higher when the wind approaches the floating wind turbine installation 20 at an angle θ of 0° compared to when the wind approaches the floating wind turbine installation 20 at an angle θ of 180°. For example, at an average wind speed of 10.5 ms⁻¹ at the nominal nacelle height the available wind energy was found to be approximately 6% higher when the wind approaches the floating wind turbine installation 20 at an angle θ of 0° compared to when the wind approaches the floating wind turbine installation 20 at an angle θ of 180°.

The simulated effect that the direction of the wind has on the power production of a wind turbine having a rated wind speed of 11 ms⁻¹ is shown in FIGS. 10A-C. The simulated maximum power production is shown in FIG. 10A, the simulated mean power production is shown in FIG. 10B, and the simulated minimum power production is shown in FIG. 10C. From FIG. 10B it can be seen that the mean power production is consistently greater at around rated wind speed when the wind approaches the floating wind turbine installation 20 at an angle θ of 0° compared to an angle θ of 180°.

The simulated roll motion of the floating wind turbine structure 11 having a mooring system as shown in FIG. 3 is shown in FIGS. 11A-C. FIG. 11A shows the simulated maximum roll motion, FIG. 11B shows the simulated mean roll motion, and FIG. 11C shows the simulated minimum roll motion.

The simulated yaw motion of the same floating wind turbine structure 11 is shown in FIGS. 12A-C. FIG. 12A shows the simulated maximum yaw motion, FIG. 12B shows the simulated mean yaw motion, and FIG. 12C shows the simulated minimum yaw motion.

The simulated pitch motion of the same floating wind turbine structure 11 is shown in FIGS. 13A-C. FIG. 13A shows the simulated maximum pitch motion, FIG. 13B shows the simulated mean pitch motion, and FIG. 13C shows the simulated minimum pitch motion.

The tower bottom bending moments for the simulated floating wind turbine installation 20 are shown in FIGS. 14A-12C. FIG. 14A shows the maximum bottom bending moments, FIG. 14B shows the mean bottom bending moments, and FIG. 14C shows the minimum bottom bending moments.

FIGS. 11-14 show that the roll, yaw and pitch motions of the floating wind turbine structure 11 and the loads on the floating wind turbine structure 11 are of the same order of magnitude when the wind approaches the floating wind turbine installation 20 from an angle θ of 0° and an angle θ of 180°.

I claim:

1. A floating wind turbine installation, comprising an asymmetric floating wind turbine structure tethered to the floor of a body of water by a mooring system, wherein:
the floating wind turbine structure comprises a wind turbine mounted on a semi-submersible floating platform, and
the floating wind turbine structure is held in position by the mooring system such that the wind turbine is positioned on an upwind side of the centre of mass of the floating wind turbine structure in the direction of the prevailing wind at the location of the wind turbine installation.

2. A floating wind turbine installation as claimed in claim 1, wherein an angle between the prevailing wind direction and a straight line passing through the position of the wind turbine and the centre of mass of the floating wind turbine installation is 60° or less.

3. A floating wind turbine installation as claimed in claim 1, wherein the wind turbine is positioned substantially directly upwind of the centre of mass of the floating wind turbine structure in the direction of the prevailing wind.

4. A floating wind turbine installation as claimed in claim 1, wherein the semi-submersible floating platform comprises three columns connected by connecting members in a ring configuration.

5. A floating wind turbine installation as claimed in claim 4, wherein the wind turbine is supported on one of the columns of the semi-submersible floating platform.

6. A floating wind turbine installation as claimed in claim 5, wherein the mooring system comprises four mooring lines connected to the floating wind turbine structure,
wherein two mooring lines of the four mooring lines are connected to the column supporting the wind turbine, and
wherein the other two mooring lines of the four mooring lines are respectively connected to a different one of the other two of the three columns.

7. A floating wind turbine installation as claimed in claim 6, wherein the mooring lines are connected directly to the floating wind turbine structure.

8. A floating wind turbine installation as claimed in claim 4, wherein the mooring system comprises three mooring lines connected to the floating wind turbine structure,
wherein each mooring line of the three mooring lines is connected to the floating wind turbine structure by a respective bridle comprising two bridle lines, with each of the two bridle lines being connected to a different one of the columns of the semi-submersible platform such that the respective mooring line is connected to two columns of the semi-submersible platform.

9. A floating wind turbine installation as claimed in claim 8, wherein each column of the three columns is connected to two of the three mooring lines.

10. A floating wind turbine installation as claimed in claim 5, wherein the mooring system comprises three mooring lines connected to the floating wind turbine structure,
wherein two mooring lines of the three mooring lines are connected to the column supporting the wind turbine, and
wherein the other mooring line of the three mooring lines is connected to the other two of the three columns via a bridle.

11. A floating wind turbine installation as claimed in claim 10, wherein the two mooring lines connected to the column supporting the wind turbine are directly connected to the column.

12. A floating wind turbine installation as claimed in claim 1, wherein the mooring system comprises a plurality of mooring lines connected, directly or indirectly, to the floating wind turbine structure.

13. A floating wind turbine installation as claimed in claim 12, wherein at least one mooring line is connected to the floating wind turbine structure by a bridle.

14. A floating wind turbine installation as claimed in claim 6, wherein the mooring lines are catenary mooring lines.

15. A floating wind turbine installation as claimed in claim 1, wherein the mooring system is an asymmetric mooring system.

16. A floating wind turbine installation as claimed in claim 15, wherein the mooring system comprises two mooring lines that are connected to the floating wind turbine structure by respective bridles having a first length, and a third mooring line that is connected to the floating wind turbine structure by a bridle having a second length that is shorter than the first length.

17. A floating wind turbine installation as claimed in claim 1, wherein the wind turbine comprises a tower and a rotor mounted at an upper end of the tower, wherein the rotor comprises a rotor hub and a plurality of blades mounted to the hub.

18. A method of mooring an asymmetric floating wind turbine structure in a body of water, wherein the floating wind turbine structure comprises a wind turbine mounted on a semi-submersible floating platform, the method comprising tethering the floating wind turbine structure to the floor of the body of water using a mooring system such that the floating wind turbine structure is held in position by the mooring system with the wind turbine positioned on an upwind side of the centre of mass of the floating wind turbine structure in the direction of the prevailing wind at the location of the floating wind turbine structure.

19. A method as claimed in claim 18, wherein the floating wind turbine structure and the mooring system form a floating wind turbine installation as claimed in claim 1.
